(19) United States
(12) Patent Application Publication
(10) Pub. No.: US 2008/0044310 A1
(43) Pub. Date: Feb. 21, 2008

(54) Chemical residue indicator

(76) Inventor: David J. Haas, Suffern, NY (US)

Correspondence Address: Michael E. Zall, Two Yorkshire Drive, Suffern, NY, 10901, US

(21) Appl. No.: 11/506,918

(22) Filed: Aug. 21, 2006

(51) Int. Cl. G01N 31/22

(52) U.S. Cl. 422/58

(57) ABSTRACT

An indicator that is an adhesive label-like testing indicator that is used to detect the presence of trace chemical residues, e.g., explosive compound residues or other hazardous chemicals. The indicator comprises a substrate, preferably transparent, having an upper surface and a lower surface and a first portion and a second portion joined at a fold line, the first portion being smaller in area than the second portion. A pressure sensitive adhesive coats the upper surface of at least the second portion of the substrate. A first reactant is adhered to the upper surface of the first portion of the substrate. When the upper surface of the second portion, is contacted with a surface containing the trace chemical residues, e.g., the handle of a briefcase, the chemical residue adheres to the adhesive. When the first portion is subsequently folded along the fold line so that the upper surfaces of the substrate contact each other, a portion of the adhesive on the second portion remains exposed. This exposed portion may be used to attach the indicator to an article, e.g., a passport or the article tested. Subsequently, over a period of time, the first reactant and any chemical residue present react with each other to provide a color indicia indicating the presence of the chemical residue.

### BACKGROUND OF THE INVENTION

1. Field of the Invention

This invention relates to a disposable sticker that can be used by security personnel guarding a secure area, e.g., airport, airplane, or other transportation vehicle, for detecting the presence of trace amounts of a predetermined chemical residue, e.g., explosives, explosive ingredient, hazardous chemical, biochemical, narcotic, for example on the surface or handle of a briefcase, piece of luggage, or package, that a person is carrying when they enter the secure area.

Additionally, this invention relates to a chemical residue indicator that provides a positive, visible indication that the article to which it is affixed has been tested for a predetermined type of chemical residue and clearly indicates the results of such test.

2. Related Art

It is a common practice for security personnel to inspect and test packages, purses, etc. for dangerous, illegal or hazardous items prior to persons entering secure areas, e.g., airports, public events, etc. In particular, security personnel often inspect and test containers and vehicles for hazardous materials or devices, particularly explosive devices and chemical residues left by such devices and hazardous materials.

There are numerous electronic devices which are available to test for such chemicals. Many of these devices perform their designed functions well, however they are generally, large and expensive devices that are impractical to install at the tens of thousands of locations that today's environment demands. Additionally, very often such inspections need to occur on the street, in a garage, on an airport tarmac, where access to sophisticated testing equipment is limited, impractical or impossible.

There are also a number of non-electronic, chemical trace explosives and hazardous material testers on the market. In all cases, they have liquids in vials or aerosols which are employed to perform color change reactions that indicate the presence or absence of these hazardous materials. Because the testing process requires the security personnel to handle several items, such as liquids, swabs, paper sampling sheets, the testing process is normally time consuming, complicated, and not easily performed in the field. Such testers require the security person to store and retrieve the various components and to manipulate them in an environment that may not be suitable for such testing.

Often inspected articles, typically hand-carried articles, do not need to be tagged after inspection because the articles may be entering into a secure location, e.g., a luggage handling area of an airport. However, often an inspection is performed at a location in a non-secure area (airport security screening station) and subsequently the person must show in another area (airplane boarding area) that the article was inspected. This requires that a visible inspection indicia, e.g., sticker, be attached to the inspected article.

### SUMMARY OF THE INVENTION

The indicator of this invention is an adhesive label-like testing indicator that is used to detect the presence of trace chemical residues, e.g., explosive compound residues or other hazardous chemicals. The indicator comprises a substrate, preferably transparent, having an upper surface and a lower surface and a first portion and a second portion joined at a fold line, the first portion being smaller in area than the second portion. A pressure sensitive adhesive coats the upper surface of at least the second portion of the substrate. A first reactant is adhered to the upper surface of the first portion of the substrate. When the upper surface of the second portion, is contacted with a surface containing the trace chemical residues, e.g., the handle of a briefcase, the chemical residue adheres to the adhesive. When the first portion is subsequently folded along the fold line so that the upper surfaces of the substrate contact each other, a portion of the adhesive on the second portion remains exposed. This exposed portion may be used to attach the indicator to an article, e.g., a passport or the article tested. Subsequently, over a period of time, the first reactant and any chemical residue present react with each other to provide a color indicia indicating the presence of the chemical residue.

This invention is a low cost, simple to use, portable, disposable adhesive sticker indicator for trace testing for chemical residues that can be widely distributed to security personnel, such as customs agents, TSA personnel, police officers, fire department personnel, the national guard, for use on the “frontline.” The indicator provides a quick “go/no-go” color change and requires only minimal training to teach someone how to use the detector.

Because the indicator is simple and convenient to use, it is more apt to be used. Other electronic or liquid chemical trace explosive detection systems are not widely used because of their cost and complexity.

The test indicator of this invention is always ready for use—no warm up or calibration is required, as do electronic devices. The screening of the article can be performed in place, it does not have to be brought to a central screening point. The indicator can be adhesively attached to the object being tested, so that no writing or documentation is required to link the test results to the article.

The indicator of this invention permits items to be tested while people are waiting in line, and while waiting, the color develops indicating the test results.

Additionally, the indicator lays flat so that it can be attached to documents and objects and the test color appears rapidly.

Additionally, after activation, the indicator cannot be reused.

Further, because the indicator can be viewed by several security personnel, it is difficult for one or more persons to permit an insecure package from entering a facility.

Still further, the test can be performed with only one hand, thus permitting the testing personnel the opportunity to hold the article being tested or if necessary, to hold a weapon.

### BRIEF DESCRIPTION OF THE DRAWINGS

Other important benefits and features of the invention will be apparent from the following Detailed Description of the Invention taken in connection with the accompanying drawings in which:

FIG. 1 shows a preferred construction and configuration of the indicator 20 of this invention.

FIG. 2 is a schematic cross-section of the first portion 30 of indicator 20 prior to activation.

FIG. 3 is a schematic perspective view of the indicator 20 just prior to activation.

FIG. 4 is a plan view of the indicator 20 just after activation.

FIG. 5 is a plan view of the indicator 20 a period of time after activation.

FIG. 6 shows another embodiment of the indicator 61 of this invention.

FIG. 7 is a schematic perspective view of indicator 61 just prior to activation.

FIG. 8 is a plan view of the indicator 61 just after activation.

FIG. 9 is a is a plan view of the indicator 61 a period of time after activation

FIG. 10 shows another embodiment of the indicator 90 of this invention.

FIG. 11 is a is a plan view of the indicator 90 a period of time after activation.

FIG. 12 shows another embodiment of the indicator 90 of this invention.

FIG. 13 shows another embodiment of the indicator of this invention.

FIG. 14 shows the embodiment of the indicator of FIG. 13 after activation.

### DETAILED DESCRIPTION OF THE INVENTION

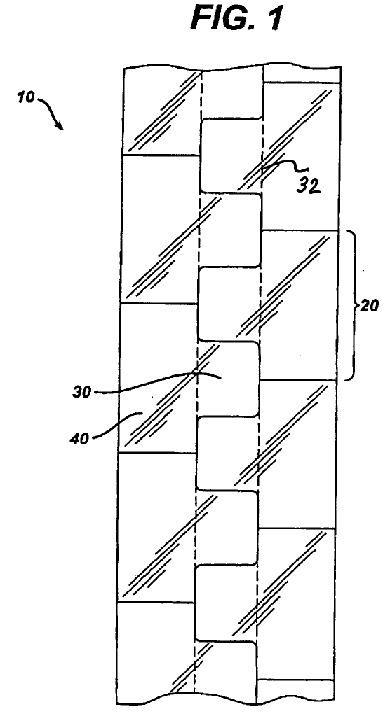

The shape and construction of several embodiments of the testing indicator are shown in FIGS. 1-14.

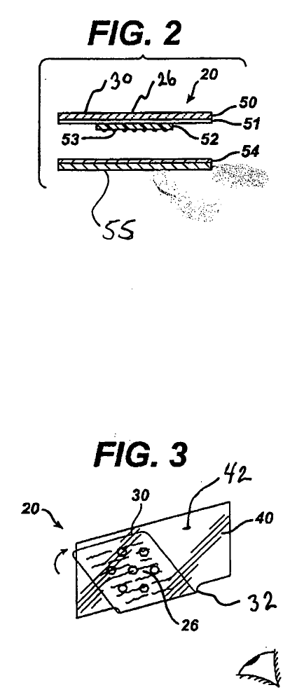

FIG. 1 shows the preferred construction of the indicator 20. The components of the first portion 30 of indicator 20 are shown in schematic in FIG. 2. Referring to FIGS. 1 and 2, the preferred indicator 20 comprises a clear substrate 50 which forms the face stock for the web assembly 10. Substrate 50 may, for example be a polyester film with thickness of 1 to 10 mils. The substrate 50 is clear so that the color change caused by reactant 53 can be viewed. Printing maybe applied to the front of the substrate 50. Such printing could be instructions, such as fold-over or fold-here. Other print indicia can be provided, for example to indicate the type testing indicator. Additionally or optionally, a security indicia can be provided to prevent counterfeiting or removal from a surface to substitute another sticker in its place.

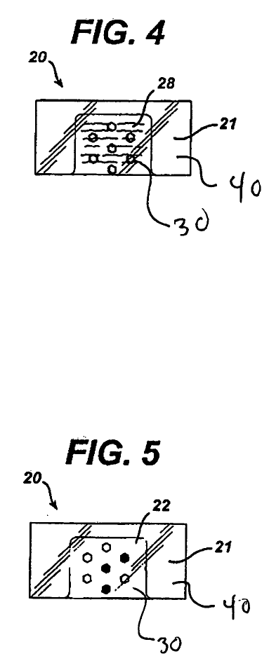

Referring to FIGS. 1 and 3, web 10 may be die-cut into a plurality of indicators 20. The indicators could be of any shape that is convenient to the user, e.g., rectangular, round, or the preferred T shape as shown herein. As shown in FIGS. 2 and 3 The T shape permits the first portion 30 which has the display surface 26 thereon to be easily folded over along the fold line 32 onto the second portion 40 which has the adhesive sampling surface 42 thereon. Such construction permits the display surface 26, 30 to stick to the adhesive surface 42 that is on the second portion 40 leaving a portion of the adhesive area 42 surrounding the first portion 30 (21 in FIGS. 4 and 5) exposed to permit attachment of the indicator 20 to the article tested or to documents associated with the person carrying the article tested.

Referring to FIG. 2, on the underside of the clear substrate 50 is clear adhesive 51 which may have various organic compositions mixed within the adhesive 51 to form the color forming compositions, e.g., a resin matrix. The adhesive coating 51 covers the entire surface of substrate 50 and is protected from the environment by a release paper 55 that has thereon a silicone coating 54. Printing, such as instructions, can be applied to the rear surface of the release liner 55.

For air sensitive materials as well as materials that lose or gain moisture, the entire indicator can be hermetically sealed. The indicator can be distributed to the user as a single unit, for example as shown in FIG. 3, or packaged in sheet form, for example as shown in FIG. 1 for use in testing numerous packages over a period of time, e.g., a users shift of employment.

Referring to FIG. 2, attached to the adhesive layer 51 and sandwiched between the face stock 50 and the release liner 55 is the display surface 52 having the color-forming reactants on the surface in contact with the silicone liner 54. The display surface is typically white for bright visibility. The color forming chemicals or reactants can be printed as a uniform coating 53 on the display surface 52 or they can be applied in patterns or bands as shown in subsequent figures.

Preferably, the display surface 52 is non-porous so as not to absorb or permit any of the organic liquids in the adhesive 51 on the clear substrate 50 to penetrate therethrough.

Referring to FIGS. 2 and 3, in a preferred embodiment, when using the indicator 20 to test for reactants, one lifts the indicator 20 off the release liner 54, 55, and then contacts and presses the adhesive 51 and reactant 53 several times to a surface to be tested, e.g., luggage handle or vehicle door, to extract a sample of any trace residue that is present.

Referring to FIG. 3, the first portion 30 or reactant display surface 26 is then folded onto the opposing adhesive 40 to initiate the reaction and color change process. (See FIGS. 4 and 5). The indicator 20, as shown in its activated (reacting) form in FIG. 4, is attached to the tested article or related documents by adhering the adhesive area 21 not covered by portion 30, to the article. One can then see the reactant display surface 26 through the clear transparent portion 30 change in color from, for example, indicia 28 in FIG. 4 to indicia 22 in FIG. 5, as the individual color reactants for specific types of chemical residue, e.g., explosives, cause the color change.

Referring to FIGS. 2 and 3, the clear substrate 50 of the web becomes the viewing window 26 on the testing sticker 20, carries a sample of the chemical residue that was collected from the tested article, and also carries the organic compounds and constituents for facilitating the reagent reactions on the display face 53 and provides adhesive 51 for the attachment of areas 21 to the article or accompanying documents.

FIG. 5, which shows the indicator 20 a period of time after activation, indicates that several of the color reacting areas 22 have turned dark and changed color, thus indicating to the tester that some explosives or other target chemicals have been detected. For security screening purposes, it may not be important for the tester to know the chemical that was detected, only that a positive response has occurred and that a more detailed scrutiny of the package and accompanying individual is required. Likewise, if the indicator does not change color, e.g., remains white, the package and associated individual can be cleared.

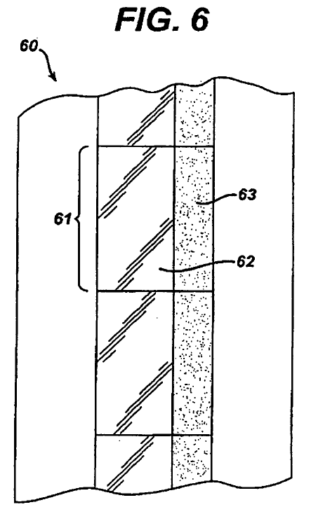

FIG. 6, depicts another embodiment the indicator 61 of this invention die-cut to a different shape, i.e., a rectangle. In this case, the web 60 is constructed exactly as shown in FIG. 2 with the display material 52 sandwiched between the adhesive face stock 51 and the silicone liner 54. The first portion 63 runs along one edge of the rectangular web 60 and leaves a second portion of the clear adhesive face stock 62 exposed.

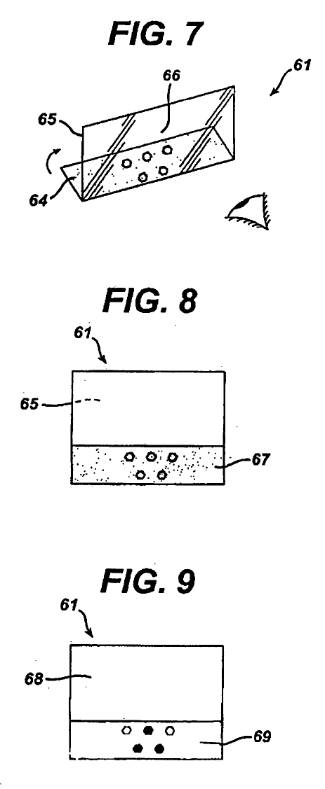

As shown in FIG. 7, the sampling for substances on articles is performed by touching the adhesive 65 to the surface of the article. The display area 64 is then folded over to initiate the color reaction sequence for testing which is viewed through window 66 in portion 62 of the test indicator 61.

FIG. 8, shows the color changing area 67 just after activation, i.e., folding. After a period of time, as shown in FIG. 9, some or the reactive area has changed color as indicia 69 appear indicating a positive test for the target chemical residue.

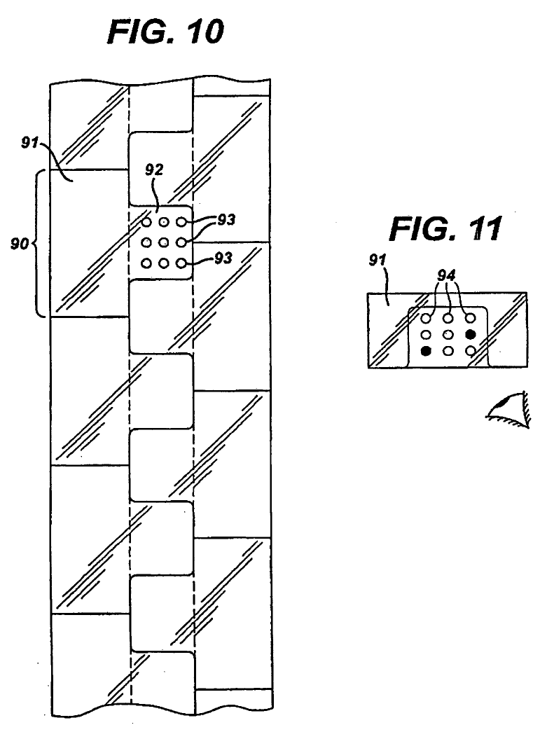

The test indicators can be printed (coated) in any pattern. As shown in FIG. 10, color forming reactants can be applied as discrete areas so that each area of reactant determines a specific substance or explosive. Optionally, the color forming reactants can be coated as a uniform mixture so that the entire surface 92 becomes the color changing area. For example, the areas 93 on flap portion 92 could each contain reactants for different explosives. In this construction, the testing indicator would sample for 9 different explosives and show which type of explosive is detected. When the test indicator is folded over, as shown in FIG. 11, the viewer looks at the array of indicia 94 and from the color change on a specific indicia 94 a determination as to the type chemical residue, e.g., explosive, could be determined.

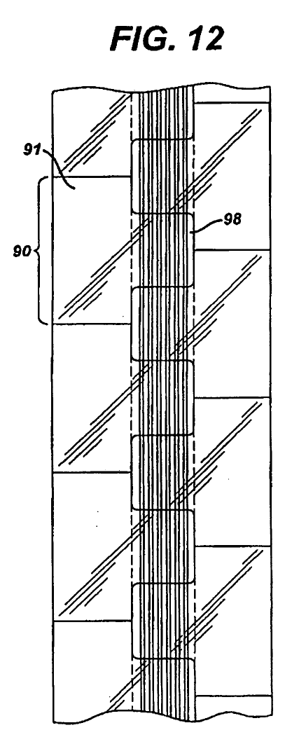

Likewise referring to FIG. 12, the color reactants have been applied as continuous bands along the display area 98. The relative position of the bands that change color would indicate the specific substance detected.

Whereas the foregoing embodiments show indicators which are a constructed of a flat substrate that can be folded over for activation, it is possible to construct the indicators having a plurality of elements which perform the same function.

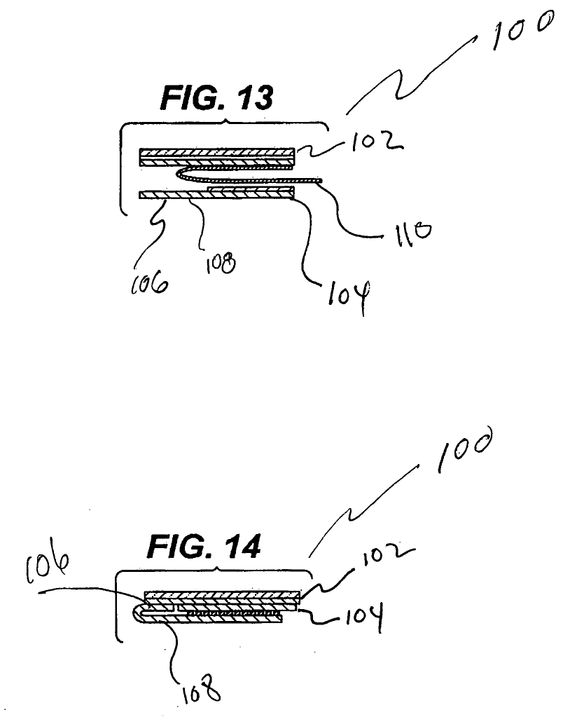

Referring to FIGS. 13 and 14, a cross-sectional view of another embodiment of the indicator 100 of the type wherein two materials 102 and 104 are attached together and the structure is activated in a similar manner of folding over a portion 106 of the structure 104 to bring the adhesive sampling area 108 into contact with the color forming reactant display area 106. More specifically, and as shown in FIGS. 13, 14, the separator 110 between the adhesive sampling surface 108 and the color forming reactants 106 is in the form of a pull tab separator 110. The tester exposes the adhesive surface 108 by removing the separator 110, contacts the adhesive with the article to sample the surface to test for the chemical residue and then folds the adhesive back 106 onto the color forming reactant display area 108.

Generally, however, it is preferred that these indicators be constructed of one-piece. A one-piece sticker can be used with one hand and the tester does not have to manipulate different pieces of paper or plastic.

These indicators or test stickers do not require any auxiliary hardware, power source, or batteries. A security person cannot be expected to assemble two or more components properly while standing in a field or on a roadway, possibly while holding a weapon. The testing person may not have a table or work surface for such assembly. It is the one-piece, self-alignment, and go/no-go color-changing construction of these testing stickers that make the invention highly beneficial.

In the preferred embodiment, the indicator of this invention has the following unique properties and benefits:

A one-piece pressure sensitive adhesive sticker that contains two chemically-independent reactive surfaces.

A pressure sensitive adhesive sticker where the two chemically-independent reactive surfaces are covered and protected from exposure to the environment and foreign matter before use.

A pressure sensitive adhesive sticker with a clear viewing window to observe any color change on either of the two reactive surfaces.

A pressure sensitive adhesive sticker where the two reactive surfaces can be brought into accurate alignment and contact with each other with the person employing only one hand.

Stickers constructed such that once the activation for testing has been initiated, the sticker can be affixed to an the article or person being tested.

These stickers or indicators are intended for use without other equipment or hardware. They are intended to be used by people in field operations(typically standing at remote locations) as well as at desk and inside facilities like airport concourses. What is more important, they are intended to be used by people who do not always have both hands available because of other tasks that they are performing. In an extreme case such as a military situation, this may be while solders are holding their weapon with one hand.

The testing stickers are intended to be used to sample the article for traces of specific substances such as explosives, narcotics, etc. Upon activating the sticker, a color change will occur if traces of the substance are detected. The chemical technologies employed in these color-changing time-stickers and the color-changing testing stickers are well known to EOD and law enforcement personnel.

Some of the elements of this invention are known, see, for example, U.S. Pat. Nos.: 5,364,132; 5,446,705; 5,602,804; 5,715,215; 5,873,606;5,719,828; 5,785,354; 5,822,280; 5,930,206; and 5,957,458. The entire disclosures of these patents are incorporated herein by reference.

An example of a detection system that could be used in this invention is described in U.S. Pat. No. 5,296,380 to Margalit, the entire disclosure of which is incorporated herein by reference. Thus, for example, to detect nitroaromatic explosives, the first reagent band could be an alkaline resin containing an diazotizable amino aromatic azo-dye precursor; for detecting organic nitrates and nitramines, the second reagent could be an acidic resin containing nitrate to nitrite ion reducing agent and a diazo-coupler; for detecting inorganic nitrates, the third resin could be a resin containing zinc powder; for detecting chlorates and bromates, the fourth reagent could be an acidic resin with inorganic nitrates and an aniline salt. Margalit states that these four color detection reagents provide an excellent system for detecting explosives.

Another example of a detection system that could be used in this invention is described in U.S. Pat. No. 4,788,039 to Glattstein, the entire disclosure of which is incorporated herein by reference. Thus, for example, the adhesive sampling layer can include a solvent such as dimethylsulfoxideand a coating of tetra-alkyl ammonium or phosphonium hydroxide on the reactant surface. Glattstein states that this change accelerates the elimination reaction of nitrate esters, producing the preferred nitrate ions which can be readily detected by a second reagent that produces the well-known Griess reaction to produce a colored azo dye. This dye color change can be viewed on the reaction surface through the clear support film which acts as the viewing window. Glattstein also states that nitroamines undergo alkaline cleavage to form nitrite ions, which produce the same colored azo compound by the Griess reaction. Likewise, polynigroaromatics form lightlycolored (violet-dark) compounds upon reaction with this reaction. Thus, this provides a multi-reagent test kit for the presumptive identification of traces of explosives. The indicator of this invention may be made “secure.” By “secure” it is meant that it cannot be removed from an article and reapplied to another article. Additionally, the indicator cannot be left on an article and used at another time. Additionally, the indicator may be made so that it is tamper indicting, i.e., an attempt to remove the indicator is obvious to one observing the indicator after it has been tampered with. Surfaces covered with pressure sensitive adhesives can be made tamper indicating and resistant to removal by a variety of conventional means.

The indicator of this invention is used for the detection of a contaminant substance, for example, explosives, drugs, poisons, etc. The inspector removes the sticker from its protective liner (e.g., silicone coated paper) and samples the suspect article by touching the adhesive portion to the surface of the article. This can be done repeatedly and the inspectors fingers can be used to press from the rear the adhesive surface of the sticker onto the sampling surface. These stickers are typically about 2″ or 3″ long in order to have enough surface area for the fingers to apply pressure. In trace explosives detection, some of the surface absorption and top surface contamination will remain attached to the adhesive of the sticker. The adhesive of these stickers will typically have organics captured in the adhesive itself, so this will assist with the transfer of the substances to the adhesive surface.

With the substrate of the sticker being a clear plastic material like 0.001″ or 0.002″ polyester, one can view the indicating surface through the exposed clear adhesive side of the sticker. The chemical reaction and color change may occur in a matter of seconds or minutes, so the tester can determine very quickly if the article has been exposed to explosive materials or other chemicals. With the remaining exposed adhesive surfaces, the sticker can be attached to the article that was just tested, or it could be attached to some document of the owner of the article such as their airline or rail ticket.

Whereas the configuration of the testing sticker can be a variety of forms such as those shown in the Figures, a rectangular configuration, and others, each configuration possesses the four specific functional components required in the testing function: 1) the adhesive sampling surface, 2) the color-forming reactant surface, 3) the fold-over activation (and alignment) property, and 4) the clear viewing window property.

Depending on whichever configuration is used, the sticker can provide the very important (additional) property of attaching the testing sticker to the article or to documents associated with the article tested. Since the testing sticker will provide verification results of the security or analytical test, it is important to be able to associate the specific testing sticker with a particular article.

The chemical reactants can be applied as discrete circles or squares on the testing sticker reactant surface or as discrete bands along the testing sticker reactant surface. Bands of reactant are preferred along the testing surface because bands of chemicals can be applied continuously from solution during the production process. From the functional point of view, bands will provide a larger area for detecting explosives on the adhesive samples surface.

A trace sample of explosive that does not cover the entire sampling surface could very well miss a small circle of reactant when the adhesive sampling surface if folded over on the reactant surface.

The indicator of this invention provides an operational process that permits screeners to perform their screening task when ever and where ever they need to. If the operation process performed by the security screener is too complicated or too clumsy, the screening test will fail to be performed properly or will not be performed at all.

Some of the other benefits of this detector (sticker) are:

Carrying the Detection Stickers: The indicators are provided on flat sheets that are unbreakable and hundreds of them can fit into a small envelope, and have an excellent “shelf life.”

Picking up the Stickers with fingers: Each sticker has a dry tab for lifting off the release liner. This can be done with only one hand which is a benefit in the field where a screener may be carrying a weapon or be holding onto to something. Also, because of the tactile feel, retrieving stickers may even be performed under windy, dusty, dark, and rainy circumstances. This provides a substantial operational benefit outdoors over a multiple part kit that requires a work surface.

Sampling an article or vehicle: Because of the T shape construction of the sticker, the screener will hold the adhesive sampler with its extending tab. This provides a convenient arrangement for the fingers to press onto the sampling area to retrieve the trace specimen.

Performing the test: The screener performs the test by simply folding over the adhesive sample area onto the testing area. This brings the reactants for the color test into contact with the sampling surface which is viewed through the clear face of the Sticker. This activation can be performed with one hand by tactile feel alone. The sticker may also provide testing for more than one explosive by coating bands of reactants on the test area.

Filing and saving the sticker: Once the trace detection test has been performed, the sticker can be saved (filed/stored) by attaching it to a paper document or to the article itself by the remaining exposed adhesive at each side of the sticker body. This permits fast and positive linkage of the actual test with the article being tested.

While various changes may be made in the detailed construction and processes of this invention, it will be understood that such changes will be within the spirit and scope of the present invention. Having thus described the invention in detail, it is to be understood that the foregoing description is not intended to limit the spirit and scope thereof. What is desired to be protected by Letters Patent is set forth in the appended claims.

What is claimed is:

1. An indicator that detects the presence of a chemical residue comprising:
a substrate having an upper surface and a lower surface and a first portion and a second portion joined at a fold line, the first portion being smaller in area than the second portion;
an adhesive coating the upper surface of at least the second portion of the substrate,
a first reactant adhered to the upper surface of the first portion of the substrate;
whereby when the second portion is contacted with a surface containing the chemical residue, the residue adheres to the adhesive and when the first portion is subsequently folded along the fold line so that the upper surfaces of the substrate contact each other, a portion of the adhesive on the second portion remains exposed and the first reactant and chemical residue react with each other to provide the color indicia indicating the presence of the chemical residue.

2. An indicator that detects the presence of a chemical residue comprising:
a substrate having an upper surface and a lower surface and a first portion and a second portion joined at a fold line, the first portion being smaller in area than the second portion;
an adhesive coating the upper surface of the substrate,
a first reactant adhered to the upper surface of the first portion of the substrate;
whereby when the second portion is contacted with a surface containing the chemical residue, the residue adheres to the adhesive and when the first portion is subsequently folded along the fold line so that the upper surfaces of the substrate contact each other, a portion of the adhesive on the second portion remains exposed and the first reactant and chemical residue react with each other to provide the color indicia indicating the presence of the chemical residue.

3. The indicator of claim 1, wherein the substrate is transparent.

4. The indicator of claim 1, wherein the color indicia can be viewed through the lower surface of the substrate.

5. The indicator of claim 1, wherein the substrate has thereon an indicia that indicates the chemical residue that the indicator detects.

6. The indicator of claim 1, wherein the substrate has thereon an indicia for detecting if the indicator is genuine.

7. The indicator of claim 1, further comprising a release liner removably adhered to the upper surface.

8. The indicator of claim 1, further comprising a plurality of a reactants adhered to the upper surface of the first portion of the substrate and at least one of the reactants and chemical residue react with each other to provide the color indicia indicating the presence of the chemical residue.

9. The indicator of claim 8, wherein each of the plurality of reactants is adhered to the upper surface as a discrete area on the first portion of the substrate.

10. The indicator of claim 9, wherein each of the plurality of reactants is adhered to the upper surface as a discrete area shaped as a stripe on the first portion of the substrate.

11. The indicator of claim 9, wherein each of the plurality of reactants is adhered to the upper surface as a discrete substantially circular area on the first portion of the substrate.

12. A web comprising a plurality of the indicators of claim 1 removably adhered to the web at the upper surface of each indicator.

13. An indicator that detects the presence of a chemical residue comprising:
a substrate having an upper surface and a lower surface and a first portion and a second portion, the first portion being smaller in area than the second portion;
an adhesive coating the upper surface of at least the second portion of the substrate,
a first reactant adhered to the upper surface of the first portion of the substrate;
whereby when the second portion is contacted with a surface containing the chemical residue, the residue adheres to the adhesive and when the upper surface of the first portion is subsequently attached to the upper surface of the second portion, a portion of the adhesive on the second portion remains exposed and the first reactant and chemical residue react with each other to provide the color indicia indicating the presence of the chemical residue.
